(19) United States
(12) Patent Application Publication
(10) Pub. No.: US 2024/0355530 A1
(43) Pub. Date: Oct. 24, 2024

(54) INPUT/OUTPUT MODULE AND CONTROL SYSTEM

(71) Applicant: ABB SCHWEIZ AG, Baden (CH)

(72) Inventors: Wengong Deng, Hangzhou (CN); Huan Shi, Hangzhou (CN); Wei Liu, Hangzhou (CN)

(21) Appl. No.: 18/762,731

(22) Filed: Jul. 3, 2024

Related U.S. Application Data
(63) Continuation of application No. PCT/CN2022/076924, filed on Feb. 18, 2022.

(51) Int. Cl. H01F 27/28

(52) U.S. Cl. CPC H01F 27/2804; H01F 2027/2833

(57) ABSTRACT

Embodiments of present disclosure relate to an input/output (I/O) module and a control system. The I/O module includes at least two coreless communication transformers arranged in parallel, each coreless communication transformer which includes a printed circuit board. The I/O module also includes a primary winding and a secondary winding disposed on opposite sides of the PCB, and at least two closed wires disposed coaxially on the PCB and arranged around the primary winding or inside the primary winding. The crosstalk of the I/O module is reduced and the communication robustness of the I/O module is improved.

### FIELD

Embodiments of the present disclosure generally relate to the field of input/output (I/O) module of a control system.

### BACKGROUND

A coreless communication transformer may be used in small-scale equipment for communication. For example, the coreless communication transformer may be used in an input/output (I/O) module of a programmable logic controller (PLC) or a distributed control system (DCS). When implemented, the coreless communication transformers are installed in parallel and a distance between adjacent coreless communication transformers is very small. As a result, a magnetic field outside one coreless communication transformer may disturb other nearby electronic systems or nearby coreless communication transformer(s), resulting in high crosstalk and low communication robustness of the I/O module. Thus, there is a need to reduce a distribution range of the magnetic field generated by the coreless communication transformer so as to reduce the crosstalk and improve the communication robustness of the I/O module.

### SUMMARY

In view of the foregoing problems, various example embodiments of the present disclosure provide an improved coreless communication transformer to reduce crosstalk and improve the communication robustness of the I/O module.

In a first aspect of the present disclosure, example embodiments of the present disclosure provide an input/output (I/O) module for communication. The I/O module comprises at least two coreless communication transformers arranged in parallel, each coreless communication transformer comprising: a printed circuit board, PCB; a primary winding and a secondary winding disposed on opposite sides of the PCB; and at least two closed wires disposed coaxially on the PCB and arranged around the primary winding or inside the primary winding.

With these embodiments, the at least two closed wires can reduce a radiation distance of the magnetic field of the coreless communication transformer, thereby reducing the crosstalk between the coreless communication transformers installed in parallel. In this way, the communication robustness of the I/O module can be improved. In addition, the improved coreless communication transformer is realized in the PCB without increasing the thickness of the transformer. This facilitates a miniaturization of the I/O module.

In some embodiments, the primary winding is provided with a current with a frequency of 4-16 MHz, preferably 8 MHz, to produce a first magnetic field; and wherein the at least two closed wires are configured to produce a second magnetic field having a direction opposite to the first magnetic field under the induction of the first magnetic field. With these embodiments, the coreless communication transformer can work in a high frequency range and ensure the stability of signal transmission.

In some embodiments, the primary winding and the secondary winding are made of copper. With these embodiments, the primary winding and the secondary winding are easily integrated in the PCB.

In some embodiments, the at least two closed wires are arranged around the primary winding, and each coreless communication transformer further comprises a first additional closed wire arranged inside the primary winding on the PCB. With these embodiments, the magnetic field outside the primary winding can be further adjusted and/or reduced so as to weaken the crosstalk between adjacent coreless communication transformers and maintain the required magnetic field strength inside the primary winding.

In some embodiments, the at least two closed wires are arranged inside the primary winding, and each coreless communication transformer further comprising a second additional closed wire arranged around the primary winding on the PCB. With these embodiments, the magnetic field outside the primary winding can be further adjusted and/or reduced so as to weaken the crosstalk between adjacent coreless communication transformers and maintain the required magnetic field strength inside the primary winding.

In a second aspect of the present disclosure, example embodiments of the present disclosure provide a control system. The control system comprises a first device, a second device; and an I/O module according to the first aspect of the present disclosure for connecting the first device and the second device. With these embodiments, it is possible to reduce the crosstalk between the coreless communication transformers of the I/O module. In this way, the communication robustness of the control system can be improved.

In some embodiments, the first device comprises a controller and the second device comprises a robot or a sensor.

It is to be understood that the Summary section is not intended to identify key or essential features of embodiments of the present disclosure, nor is it intended to be used to limit the scope of the present disclosure. Other features of the present disclosure will become easily comprehensible through the following description.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in examples and in a non-limiting manner, wherein:

FIG. 1 is a schematic view of an I/O module according to embodiments of the present disclosure;

FIG. 2 is a side view of a coreless communication transformer of an I/O module of FIG. 1;

FIG. 3 is a side view of a coreless communication transformer of an I/O module of FIG. 1;

FIG. 4 is a side view of a coreless communication transformer of an I/O module of FIG. 1; and

FIG. 5 is a side view of a coreless communication transformer of an I/O module of FIG. 1.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art to better understand and thereby implement the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

According to embodiments of the present disclosure, at least two closed wires are arranged around the primary winding or arranged inside the primary winding so as to limit the magnetic field outside the primary winding. In this way, the crosstalk between adjacent coreless communication transformers can be reduced.

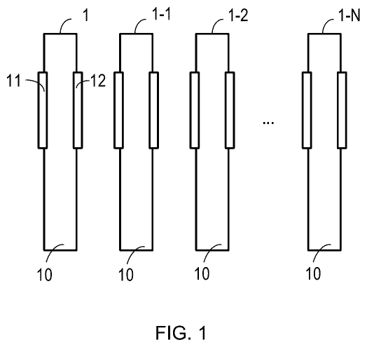

FIG. 1 shows a schematic view of an I/O module for communication according to embodiments of the present disclosure. As shown in FIG. 1, the I/O module comprises at least two coreless communication transformers. The at least two coreless communication transformers 1, 1-1, 1-2, . . . , 1-N are arranged in parallel. In this way, the at least two coreless communication transformers 1, 1-1, 1-2, . . . , 1-N are arranged in sequence, and a small distance exists between adjacent coreless communication transformers.

Each of the coreless communication transformers 1, 1-1, 1-2, . . . , 1-N comprises a corresponding printed circuit board (PCB) 10. A primary winding 11 and a secondary winding 12 are disposed on opposite sides of each PCB. In some embodiments, the primary winding 11 and the secondary winding 12 are made of copper.

When a current is provided to the primary winding 11, the primary winding 11 will generate a first magnetic field. Under the influence of the first magnetic field, an induced current will be induced in the secondary winding 12. Thus, a signal for communication can be generated according to the change of the induced current in the secondary winding 12. In this way, the coreless communication transformer can be used for signal transmission.

In some embodiments, the primary winding 11 may be provided with a current with a frequency of 4-16 MHz, preferably 8 MHz, to produce the first magnetic field. In some embodiments, the current provided to the primary winding 11 may be a square signal of 8 MHz.

As discussed above, since the distance between adjacent coreless communication transformers is very small, the magnetic field outside the coreless communication transformer may disturb other nearby electronic systems or nearby coreless communication transformer(s). In order to reduce the crosstalk between adjacent coreless communication transformers, the at least two closed wires 20, 21 are disposed coaxially on the PCB. The at least two closed wires 20, 21 can produce a second magnetic field having a direction opposite to the first magnetic field under the induction of the first magnetic field. In this way, the magnetic field outside the primary winding 11 can be weakened so as to reduce the crosstalk.

In some embodiments, each of the at least two closed wires 20, 21 may be a circular shaped closed wire or a rectangle shaped closed wire. In other embodiments, the shape of the closed wire may be of other shapes, such as a square shape or a polygonal shape. The scope of the present disclosure is not intended to be limited in this respect.

According to embodiments of the present disclosure, the at least two closed wires are disposed on the PCB around the primary winding or inside the primary winding.

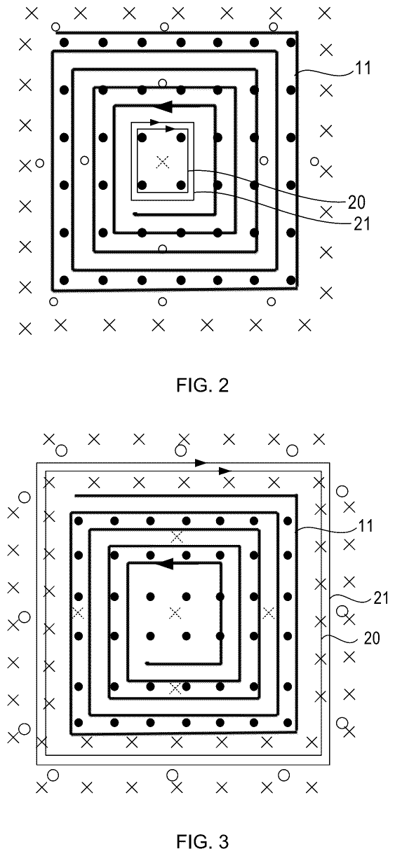

FIGS. 2-3 respectively show a side view of a coreless communication transformer of an I/O module of FIG. 1. The other coreless communication transformer(s) of the I/O module are the same as the coreless communication transformer(s) shown in FIG. 2 or FIG. 3.

FIGS. 2-3 take a square shaped primary winding 11 as an example to describe embodiments of the present disclosure. It should be understood that the shape of the primary winding 11 may be of other shapes, such as a circular shape. The scope of the present disclosure is not intended to be limited in this respect.

As shown in FIG. 2, the at least two closed wires 20, 21 are arranged inside the primary winding 11. As such, the at least two closed wires 20, 21 are encompassed by the primary winding 11. The arrow lying in the primary winding 11 shows a direction of a current flowing through the primary winding 11, for example, in a counterclockwise direction. According to the law of electromagnetic induction, the primary winding 11 will generate a first magnetic field. Magnetic lines of the first magnetic field are shown by the label X and solid circle in FIG. 2.

In FIG. 2, the label X means that the direction of a magnetic line of the first magnetic field outside the primary winding 11 is downward, and the solid circle means that the direction of the magnetic line inside the primary winding 11 is upward.

With the first magnetic field, an induced current will be generated in the at least two closed wires 20, 21. The direction of the induced current of the closed wires 20, 21 is shown by an arrow on the closed wires 20, 21, for example, in a clockwise direction. The induced current produced in the at least two closed wires 20, 21 will generate an induced magnetic field which is shown by the label x and hollow circle in FIG. 2. The label X means that the direction of a magnetic line of the induced magnetic field outside the closed wires 20, 21 is downward, and the hollow circle means that the direction of the magnetic line inside the closed wires 20, 21 is upward.

As shown in FIG. 2, in the area outside the primary winding 11, the magnetic line of the induced magnetic field is opposite to the magnetic line of the first magnetic field. Thus, the magnetic field outside the primary winding 11 is weakened. As a result, the influence of the magnetic field outside the primary winding 11 on the nearby electronic systems and/or nearby coreless communication transformers is reduced, and thus the communication robustness of the I/O module can be improved.

With the at least two closed wires 20, 21, the magnetic field outside the primary winding 11 can be significantly weakened and the shape of the first magnetic field tends to be flat. As such, the crosstalk between adjacent coreless communication transformers can be reduced.

As shown in FIG. 3, the at least two closed wires 20, 21 are arranged around the primary winding 11. As such, the primary winding 11 is encompassed by the at least two closed wires 20, 21. The arrow lying in the primary winding 11 shows a direction of a current flowing through the primary winding 11, for example, in a counterclockwise direction. According to the law of electromagnetic induction, the primary winding 11 will generate a first magnetic field. Magnetic lines of the first magnetic field are shown by the label X and solid circle in FIG. 3.

In FIG. 3, the label X means that the direction of a magnetic line of the first magnetic field outside the primary winding 11 is downward, and the solid circle means that the direction of the magnetic line inside the primary winding 11 is upward.

With the first magnetic field, an induced current is generated in the at least two closed wires 20, 21. The direction of the induced current of the closed wires 20, 21 is shown by an arrow on the closed wires 20, 21, for example, in a clockwise direction. The induced current produced in the at least two closed wires 20, 21 will generate an induced magnetic field which is shown by the label and hollow circle in FIG. 2. The label X means that the direction of a magnetic line of the induced magnetic field outside the closed wires 20, 21 is downward, and the hollow circle means that the direction of the magnetic line inside the closed wires 20, 21 is upward.

As shown in FIG. 3, in the area outside the primary winding 11, the magnetic line of the induced magnetic field is opposite to the magnetic line of the first magnetic field. Thus, the magnetic field outside the primary winding 11 is weakened. As a result, the influence of the magnetic field outside the primary winding 11 on the nearby electronic systems and/or nearby coreless communication transformers is reduced, and thus the communication robustness of the I/O module is improved.

With the at least two closed wires 20, 21, the magnetic field outside the primary winding 11 can be significantly weakened and the shape of the first magnetic field tends to be flat. As such, the crosstalk between adjacent coreless communication transformers can be reduced and thus the communication robustness of the I/O module is improved.

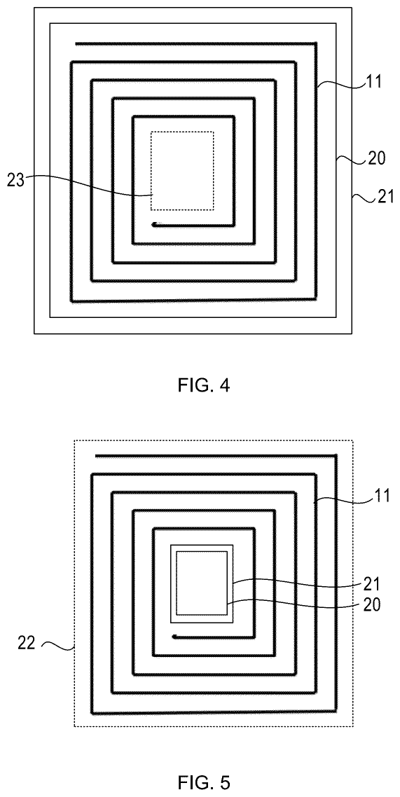

In some embodiments, additional closed wires may be arranged on the PCB of the coreless communication transformer to further reduce or adjust the magnetic field outside the primary winding 11. FIG. 4 is a side view of a coreless communication transformer of an I/O module of FIG. 1 and FIG. 5 is a side view of a coreless communication transformer of an I/O module of FIG. 1. The other coreless communication transformer(s) of the I/O module are the same as the coreless communication transformer(s) shown in FIG. 4 or FIG. 5.

FIGS. 4-5 take a square shaped primary winding 11 as an example to describe embodiments of the present disclosure. It should be understood that the shape of the primary winding 11 may be of other shapes, such as a circular shape. The scope of the present disclosure is not intended to be limited in this respect.

In some embodiments, each coreless communication transformer further comprises a first additional closed wire 23 arranged on the PCB. As shown in FIG. 4, the at least two closed wires 20, 21 are arranged around the primary winding 11 and the first additional closed wire 23 is arranged inside the primary winding 11. With the first additional closed wire 23, the magnetic field outside the primary winding 11 can be further adjusted so as to weaken the crosstalk between adjacent coreless communication transformers and maintain the required magnetic field strength inside the primary winding 11.

It should be understood that the number of the first additional closed wire may be one, two, three or more. The scope of the present disclosure is not intended to be limited in this respect.

In some embodiments, each coreless communication transformer further comprises a second additional closed wire 22 arranged on the PCB. As shown in FIG. 5, the at least two closed wires 20, 21 are arranged inside the primary winding 11 and the second additional closed wire 22 is arranged around the primary winding 11. With the second additional closed wire 22, the magnetic field outside the primary winding 11 can be further adjusted so as to weaken the crosstalk between adjacent coreless communication transformers and maintain the required magnetic field strength inside the primary winding 11.

It should be understood that the number of the second additional closed wire 22 may be one, two, three or more. The scope of the present disclosure is not intended to be limited in this respect.

According to some embodiments of the present disclosure, a control system is provided. The control system comprises a first device, a second device, and the I/O module discussed above. The I/O module connects the first device and the second device such that the first device and the second device can communicate via the I/O module.

In some embodiments, the first device comprises a controller. In some embodiments, the second device comprises a robot or a sensor. In this way, signal transmission between the controller and the robot or sensor can be achieved by the I/O module.

In some embodiments, the control system may comprise a programmable logic controller (PLC) or a distributed control system (DCS).

In some embodiments, with respect to each coreless communication transformer, the at least two closed wires 20, 21, the first additional closed wire 23 and the second additional closed wire 22 may be made of copper. In some embodiments, the first additional closed wire 23 and the second additional closed wire 22 may be copper trace on the PCB.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. An input/output (I/O) module for communication, comprising:
at least two coreless communication transformers arranged in parallel, wherein each coreless communication transformer includes:
a printed circuit board (PCB);
a primary winding and a secondary winding disposed on opposite sides of the PCB; and
at least two closed wires arranged coaxially on the PCB and arranged around the primary winding or inside the primary winding.

2. The I/O module of claim 1,
wherein the primary winding is provided with a current with a frequency of 4-16 MHz, preferably 8 MHz, to produce a first magnetic field; and
wherein the at least two closed wires are configured to produce a second magnetic field having a direction opposite to the first magnetic field under the induction of the first magnetic field.

3. The I/O module of claim 1, wherein the primary winding and the secondary winding are made of copper.

4. The I/O module of claim 1, wherein the at least two closed wires are arranged around the primary winding, and each coreless communication transformer further comprises a first additional closed wire arranged inside the primary winding on the PCB.

5. The I/O module of claim 1, wherein the at least two closed wires are arranged inside the primary winding, and each coreless communication transformer further comprising a second additional closed wire arranged around the primary winding on the PCB.

6. A control system comprising:
a first device and a second device; and
an I/O module according to claim 1 for connecting the first device and the second device.

7. The system of claim 6, wherein the first device comprises a controller and the second device comprises a robot.

8. The system of claim 6, wherein the first device comprises a controller and the second device comprises a sensor.

9. The system of claim 6,
wherein the primary winding is provided with a current with a frequency of 4-16 MHz, preferably 8 MHz, to produce a first magnetic field; and
wherein the at least two closed wires are configured to produce a second magnetic field having a direction opposite to the first magnetic field under the induction of the first magnetic field.

10. The system of claim 6, wherein the primary winding and the secondary winding are made of copper.

11. The system of claim 6, wherein the at least two closed wires are arranged around the primary winding, and each coreless communication transformer further comprises a first additional closed wire arranged inside the primary winding on the PCB.

12. The system of claim 6, wherein the at least two closed wires are arranged inside the primary winding, and each coreless communication transformer further comprising a second additional closed wire arranged around the primary winding on the PCB.
